(19) United States
(12) Patent Application Publication
(10) Pub. No.: US 2011/0252062 A1
(43) Pub. Date: Oct. 13, 2011

(54) ELECTRONIC DEVICE FOR SEARCHING FOR ENTRY WORD IN DICTIONARY DATA, CONTROL METHOD THEREOF AND PROGRAM PRODUCT

(76) Inventors: Naoto Hanatani, Osaka (JP); Akira Yasuta, Osaka (JP)

(21) Appl. No.: 12/680,865

(22) PCT Filed: Oct. 28, 2008
(86) PCT No.: PCT/JP2008/069539

§ 371 Date: Mar. 30, 2010

(30) Foreign Application Priority Data
Nov. 5, 2007 (JP) 2007-287580

(51) Int. Cl. G06F 17/30

(52) U.S. Cl. 707/772; 707/E17.101; 707/E17.014; 707/E17.019

(57) ABSTRACT

An electronic dictionary searches for an entry word in dictionary data, and further conducts a search based on a keyword associated with image data. The electronic dictionary first searches for a keyword as described above, then extracts an image ID associated with the keyword found by the search, extracts an entry word associated in the dictionary data with the extracted image ID, and thereafter provides the entry word.

### TECHNICAL FIELD

The present invention relates to electronic devices, and particularly to an electronic device for searching dictionary data for an entry word based on input information, a method of controlling the electronic device, and a program product.

### BACKGROUND ART

There have been many electronic devices with a dictionary capability such as electronic dictionaries. Various techniques have accordingly been disclosed for improving the usefulness of such electronic dictionaries. Japanese Patent Laying-Open No. 6-044308 (Patent Document 1) for example discloses a technique according to which an item for which a keyword is selected is specified in advance, input sentence data is divided into words, any unsuitable word is appropriately deleted from the words into which the sentence data is divided, and then the remaining words are registered in a keyword dictionary file.

With the recent advancement in technique for information processors, the performance of the components of the information processors has generally been improved, and accordingly the performance of such processors has generally been improved. Electronic dictionaries of recent years thus store not only text data but also object data such as image data and audio data as data relevant to entry words. The electronic dictionaries are therefore able to provide to users not only character information but also images and sounds as information associated with entry words, and the usefulness of the electronic dictionaries has thus been enhanced.

Patent Document 1: Japanese Patent Laying-Open No. 6-044308

### DISCLOSURE OF THE INVENTION

### Problems to be Solved by the Invention

The conventional electronic devices as described above respond to input of information by a user to search for an entry word based on the information, and can provide not only character information but also an image and/or sound associated with the entry word found by the search.

While such electronic devices provide the image and/or sound as supplemental information, some users in some cases have desired to obtain, as a result of search, an image and/or sound relevant to the information that the user has input, in addition to the entry word relevant to the user's input information. The conventional electronic devices, however, have merely handled images and sounds as supplemental information for entry words, and thus cannot perform such a search as desired by such users.

The present invention has been made in view of the circumstances above, and an object of the invention is to provide an electronic device capable of providing to a user an image and/or sound relevant to information input by the user, from images and sounds like those provided conventionally as supplemental information for entry words.

### MEANS FOR SOLVING THE PROBLEMS

An electronic device according to the present invention includes: an input unit; a search unit for searching for an entry word in dictionary data including entry words and text data and object data associated with the entry words, based on information entered via the input unit; and a relevant information storage unit for storing information associating the object data with a keyword, the search unit conducting a search to find the keyword included in the relevant information storage unit and corresponding to the information entered via the input unit, conducting a search to find the object data associated in the relevant information storage unit with the keyword found by the search, and conducting a search to find an entry word associated in the dictionary data with the found object data.

Preferably, the electronic device further includes an extraction unit for extracting the keyword from the dictionary data.

Preferably, the extraction unit of the electronic device extracts the entry word associated in the dictionary data with the object data, and the extraction unit extracts the entry word as the keyword.

Preferably, the extraction unit of the electronic device extracts data satisfying a certain condition with respect to a specific symbol, from the text data associated in the dictionary data with the object data, and the extraction unit extracts the data as the keyword.

Preferably, the electronic device further includes an input data storage unit for storing data entered via the input unit, and the extraction unit extracts, from the text data associated in the dictionary data with the object data, data identical to the data stored in the input data storage unit, and the extraction unit extracts the data as the keyword.

Preferably, in a case where the keyword extracted for the object data includes an ideogram, the extraction unit of the electronic device further extracts a character string represented by only a phonogram of the keyword, as the keyword relevant to the object data.

Preferably, the object data of the electronic device is image data.

Preferably, the object data of the electronic device is audio data.

According to the present invention, a method of controlling an electronic device for conducting a search using dictionary data stored in a predetermined storage device and including entry words and text data and object data associated with the entry words includes the steps of: storing information associating the object data with a keyword of the object data; conducting a search to find the object data stored in association with the keyword corresponding to information entered to the electronic device; and conducting a search for an entry word associated in the dictionary data with the found object data.

According to the present invention, a program product has a computer program recorded for causing a computer to execute the method of controlling an electronic device as described above.

According to the present invention, the electronic device having dictionary data in which object data is associated with an entry word stores information for associating the object data with a keyword. The electronic device uses the keyword to search for the object data corresponding to input information, and provides to a user, as a final result of the search, the entry word associated in the dictionary data with the object data found by the search.

Thus, in response to information entered by a user to the electronic device, the electronic device provides the user with an entry word, as a result of search, associated in the dictionary data with object data corresponding to the information. In other words, the user may enter information to cause object data corresponding to the information to be output by the electronic device by means of the entry word provided as a result of search.

Therefore, according to the present invention, the electronic device can provide to a user an image and/or sound relevant to information entered by the user, from images and sounds such as those having hitherto been provided as supplemental information for entry words. The usefulness of the electronic device can accordingly be enhanced.

### BRIEF DESCRIPTION OF THE DRAWINGS

FIG. 1 schematically shows a hardware configuration of an electronic dictionary implemented as an embodiment of an electronic device of the present invention.

FIG. 2 schematically shows a data structure of dictionary data stored in the electronic dictionary in FIG. 1.

FIG. 3 schematically shows a data structure of an image ID—address table stored in the electronic dictionary in FIG. 1. FIG. 4 illustrates how actual data of images are stored in the electronic dictionary in FIG. 1.

FIG. 5 schematically shows a data structure of an image—keyword table stored in the electronic dictionary in FIG. 1.

FIG. 6 schematically shows a data structure of a keyword—image ID list table stored in the electronic dictionary in FIG. 1.

FIG. 7 schematically shows a data structure of an image ID—entry word table stored in the electronic dictionary in FIG. 1.

FIG. 8 schematically shows a data structure of manually input keywords stored in the electronic dictionary in FIG. 1.

FIG. 9 shows an example of screens displayed by a display unit of the electronic dictionary in FIG. 1.

FIG. 10 shows an example of screens displayed by the display unit of the electronic dictionary in FIG. 1.

FIG. 11 shows an example of screens displayed by the display unit of the electronic dictionary in FIG. 1.

FIG. 12 shows an example of screens displayed by the display unit of the electronic dictionary in FIG. 1.

FIG. 13 shows an example of screens displayed by the display unit of the electronic dictionary in FIG. 1.

FIG. 14 shows an example of screens displayed by the display unit of the electronic dictionary in FIG. 1.

FIG. 15 shows an example of screens displayed by the display unit of the electronic dictionary in FIG. 1.

FIG. 16 is a flowchart for a process of generating an image—keyword table executed by the electronic dictionary in FIG. 1.

FIG. 17 is a flowchart for a subroutine of a process of extracting entry information in FIG. 16.

FIG. 18 is a flowchart for a subroutine of a process of extracting category information in FIG. 16.

FIG. 19 is a flowchart for a subroutine of a process of extracting a keyword from an explanatory text in FIG. 16.

FIG. 20 is a flowchart for a process of extracting another keyword executed by the electronic dictionary in FIG. 1.

FIG. 21 is a flowchart for a process of generating a keyword—image ID list table executed by the electronic dictionary in FIG. 1.

FIG. 22 is a flowchart for a link search process executed by the electronic dictionary in FIG. 1.

FIG. 23 is a flowchart for a subroutine of a process of displaying a result of search based on an input character string in FIG. 22.

FIG. 24 is a flowchart for a subroutine of a process of displaying a result of search based on a displayed image in FIG. 22.

FIG. 25 is a flowchart for a modification of the process in FIG. 22.

FIG. 26 is a flowchart for a process of a modification of the process shown in FIG. 23.

FIG. 27 is a flowchart for a process of a modification of the process shown in FIG. 24.

FIG. 28 shows an example of screens displayed by the display unit of the electronic dictionary in FIG. 1.

FIG. 29 is a flowchart for a process of searching for an image based on an input character string that is executed by the electronic dictionary in FIG. 1.

### DESCRIPTION OF THE REFERENCE SIGNS

1 electronic dictionary, 10 CPU, 20 input unit, 21 character input key, 22 enter key, 23 cursor key, 24 S key, 30 display unit, 40 RAM, 41 selected image/word storage area, 42 input text storage area, 43 candidate keyword storage area, 44 keyword selection/non-selection setting storage area, 50 ROM, 51 image—keyword table storage unit, 52 keyword—image ID list table storage unit, 53 image ID—entry word table storage unit, 54 manual input keyword storage unit, 55 dictionary DB storage unit, 56 dictionary search program storage unit, 57 image display program storage unit, 90, 100, 110, 120, 130, 140, 150, 200 screen

### BEST MODES FOR CARRYING OUT THE INVENTION

An electronic dictionary implemented as an embodiment of an electronic device of the present invention will be hereinafter described with reference to the drawings. The electronic device of the present invention is not limited to the electronic dictionary. Namely, it is intended that the electronic device of the present invention may also be configured as a device having any capability other than the electronic dictionary capability, like a general-purpose personal computer for example.

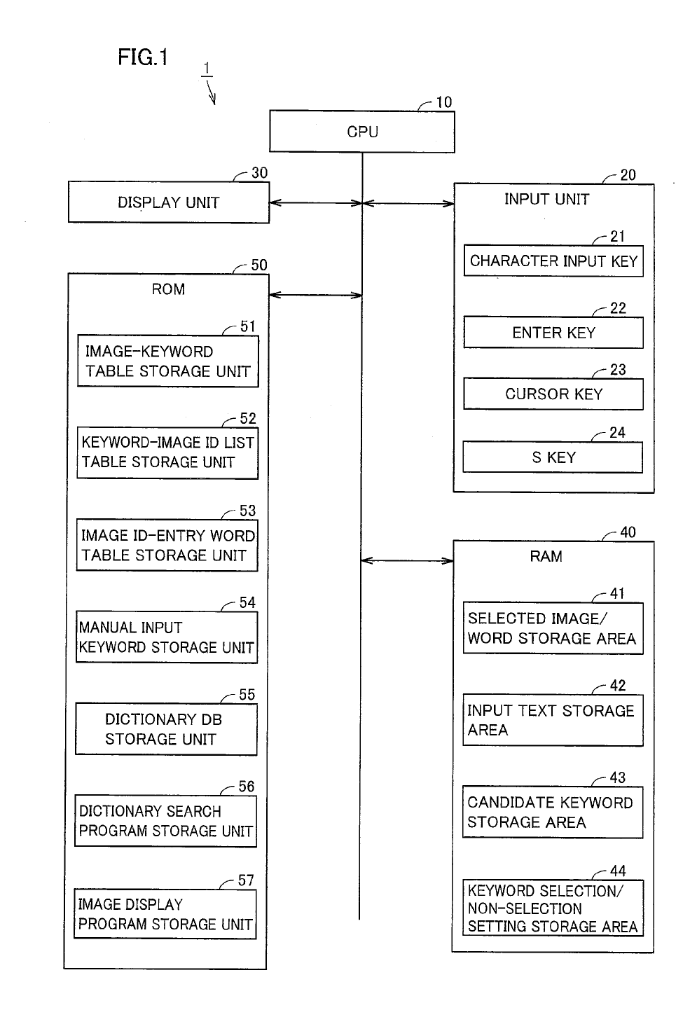

FIG. 1 schematically shows a hardware configuration of the electronic dictionary. Referring to FIG. 1, electronic dictionary 1 includes a CPU (Central Processing Unit) 10 for entirely controlling the operation of electronic dictionary 1. Electronic dictionary 1 also includes an input unit 20 for receiving information entered by a user, a display unit 30 for displaying information, a RAM (Random Access Memory) 40, and a ROM (Read Only Memory) 50.

Input unit 20 includes a plurality of buttons and/or keys. A user can manipulate them to enter information into electronic dictionary 1. Specifically, input unit 20 includes a character input key 21 for input of an entry word or the like for which dictionary data is to be displayed, an enter key 22 for input of information for confirming information being selected, a cursor key 23 for moving a cursor displayed by display unit 30, and an S key 24 used for input of specific information. RAM 40 includes a selected image/word storage area 41, an input text storage area 42, a candidate keyword storage area 43, and a keyword selection/non-selection setting storage area 44.

ROM 50 includes an image—keyword table storage unit 51, a keyword—image ID list table storage unit 52, an image ID—entry word table storage unit 53, a manual input keyword storage unit 54, a dictionary database (DB) storage unit 55, a dictionary search program storage unit 56, and an image display program storage unit 57.

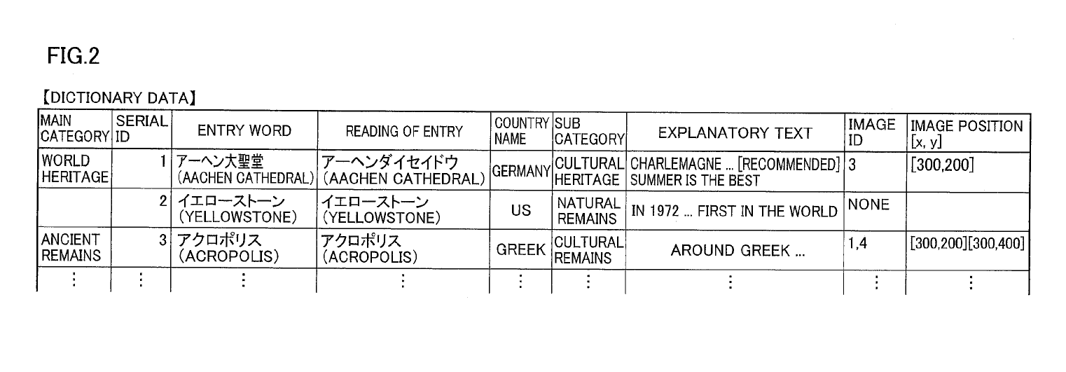

Dictionary DB storage unit 55 stores dictionary data. In the dictionary data, various data are stored in association with each of a plurality of entry words. FIG. 2 schematically shows an example of the data structure of the dictionary data.

Referring to FIG. 2, the dictionary data includes a plurality of entry words such as “Aachen Cathedral”, “Yellowstone” and “Acropolis”. FIG. 2 shows that items of information concerning each entry word are arranged laterally in one row. Each entry word is classified in two steps of “main category” and “sub category”, and information representing the main category and information representing the sub category are given to the entry word. To each entry word in the dictionary data, a unique number (“serial ID” in FIG. 2) is assigned. Further, in the dictionary data, each entry word is associated with reading in kana, namely kana characters representing how the entry word is read or pronounced, and the kana characters are stored as “reading of entry” for the entry word, and further, the name of the country (“country name” in FIG. 2) relevant to each entry word is given to the entry word. To each entry word in the dictionary data, an explanation of the entry word (“explanatory text” in FIG. 2) is also given. Further, information for identifying an image to be displayed by display unit 30 as an image associated with the entry word (“image ID” in FIG. 2), as well as information for identifying the location where the image identified by the image ID is to be displayed by display unit 30 (“image position” in FIG. 2) are also stored in association with the entry word. Some of a plurality of entry words are associated with respective image IDs and some are not.

“Reading in kana” as described above is a representation by phonogram(s) only. In the dictionary data of the present embodiment, “reading of entry” associated with an entry word is a representation of the entry word by phonogram(s) only. In other words, “reading of entry” associated with “entry word” including ideogram(s) is a representation of the ideogram(s) in “entry word” by phonogram(s) instead of the ideogram(s). In the case where a language to which the present invention is applied does not use ideograms and phonograms in combination but uses phonograms only, “reading of entry” may be a representation of “entry word” by pronunciation symbol(s).

While the present embodiment will be described where image data is used as an example of object data associated with an entry word, the object data of the present invention is not limited to image data. The object data may be image data, audio data, moving image data and/or any combination thereof.

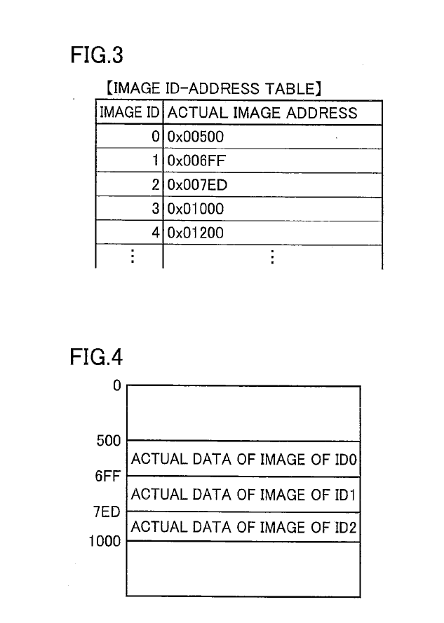

Actual data of respective images each identified by the above-described image ID are stored in dictionary DB storage unit 55 (as shown in FIG. 4 for example), separately from the above-described dictionary data. The vertical axis in FIG. 4 represents the address of a storage area where actual data of an image is stored. Dictionary DB storage unit 55 also stores an image ID—address table providing information for associating an image ID in the dictionary data with the storage location (address) of the actual data of each image. FIG. 3 schematically shows a structure of this table.

Referring to FIG. 3, the image ID—address table indicates the beginning address of the storage location of the actual data of the image associated with each image ID. In order to cause display unit 30 to display the image identified by the value of the image ID, CPU 10 refers to the image ID—address table to obtain the storage location of the actual data corresponding to the image ID, and uses the data stored at the storage location for displaying the image by display unit 30.

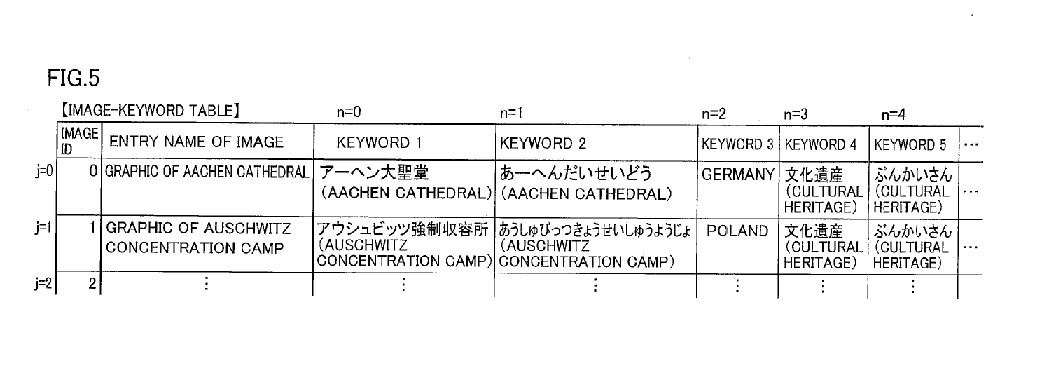

FIG. 5 schematically shows a data structure of an image—keyword table stored in image—keyword table storage unit 51.

Referring to FIG. 5, items of information concerning each image are laterally arranged in one row of the table. In this table, in the order of numerical values of image IDs, respective information items relevant to respective images are vertically arranged. An image ID in this table corresponds to a value of variable j.

In the table shown in FIG. 5, in association with each image ID, a plurality of keywords (keyword 1, keyword 2, keyword 3, . . . ) are stored together with an entry name of the image. Electronic dictionary 1 of the present embodiment produces the image—keyword table as shown in FIG. 5 based on the dictionary data as shown in FIG. 2. Specifically, based on the dictionary data as shown in FIG. 2, keywords associated with object data such as image data to be supplementally displayed (reproduced or output in the case where the object data is audio data) for each entry word are stored. Thus, when a specific condition is satisfied such as the condition that specific manipulation is performed on input unit 20 while each object is being displayed for example (or immediately after each object is reproduced for example), electronic dictionary 1 can search the dictionary data for an entry word based on the keywords (using the keywords as keys) that are associated with the object data in the image—keyword table. How the image—keyword table as shown in FIG. 5 is generated will be described later.

In the image—keyword table, variable n is defined as a variable for specifying the order of keywords associated with each image.

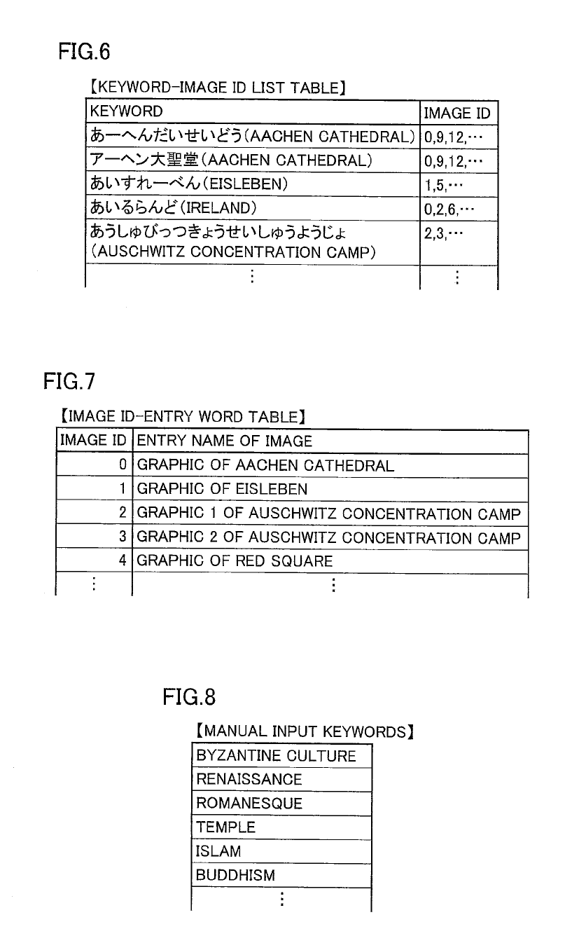

FIG. 6 schematically shows a data structure of a keyword—image ID list table stored in keyword—image ID list table storage unit 52 (see FIG. 1). Referring to FIG. 6, this table stores, for each character string stored as a keyword in FIG. 5, all images (image IDs) associated with the keyword and stored in the table of FIG. 5. FIG. 7 schematically shows an example of a data structure of an image—entry word table stored in image ID—entry word table storage unit 53 (see FIG. 1). This table stores the image ID of each image and the entry name of the image (file name of the image data identified by the image ID) in association with each other.

FIG. 8 schematically shows an example of a data structure stored in manual input keyword storage unit 54 (see FIG. 1). Here, keywords that are entered by a user by manipulating keys such as character input key 21 are stored.

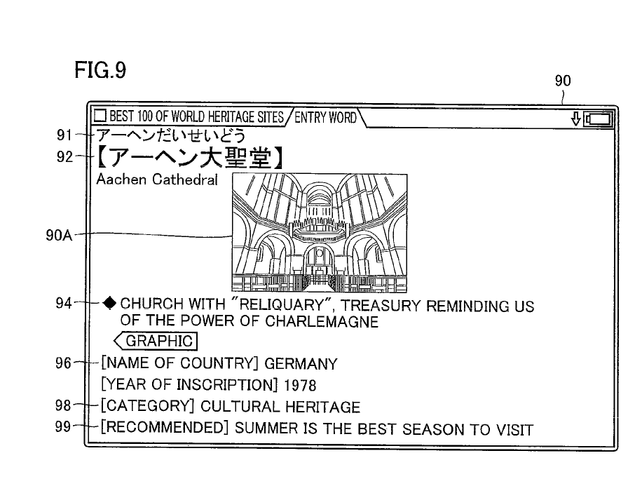

FIG. 9 shows an example of how display unit 30 displays information associated with one entry word in the dictionary data (see FIG. 2).

Referring chiefly to FIGS. 2 and 9, a screen 90 shows an information item 91 corresponding to the data stored in a cell for the reading of entry in the dictionary data, an information item 92 displayed that corresponds to the data stored in a cell for the entry word in the dictionary data, an information item 96 displayed based on the data stored in a cell for the country name in the dictionary data, an information item 98 displayed based on the data stored in a cell for the sub category in the dictionary data, an image 90A displayed based on the data stored in a cell for the image ID in the dictionary data, and information items 94, 99 displayed based on the data stored in a cell for the explanatory text in the dictionary data. The position where image 90A is to be displayed by display unit 30 is determined based on the information stored in a cell for the image position. CPU 10 performs a process following a program stored in image display program storage unit 57 to cause display unit 30 to display the data included in the dictionary data in the manner shown in FIG. 9 for example. In the case where information identifying audio data is stored in the dictionary data, CPU 10 may cause screen 90 to be displayed by display unit 30 as shown in FIG. 9 and also cause the audio file to be reproduced (output), or may cause a button to be displayed in screen 90 for instructing the audio file to be reproduced, so that the file is reproduced in response to manipulation of selecting the button.

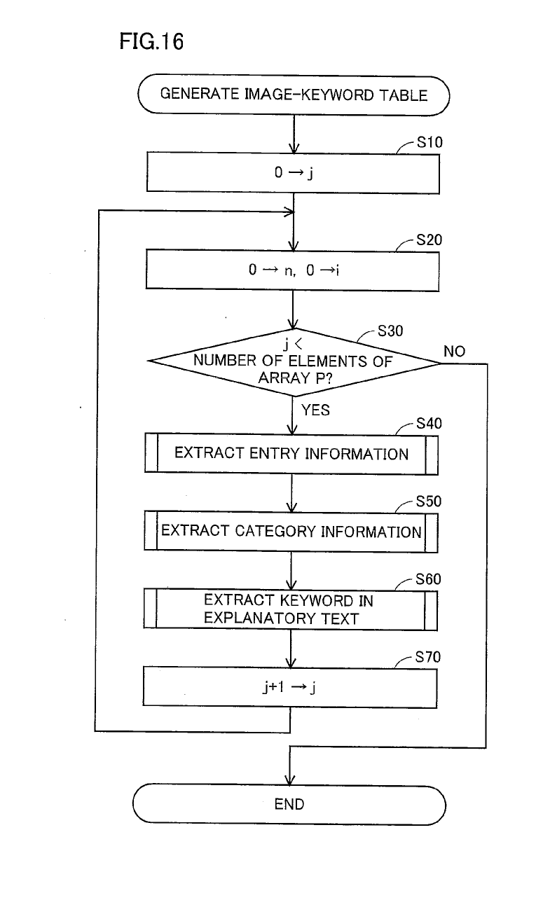

Before shipment of electronic dictionary 1 or when the dictionary data or a program for searching the dictionary data is installed in electronic dictionary 1, the image—keyword table as described above with reference to FIG. 5 is produced in electronic dictionary 1. CPU 10 produces this table, following a program stored in dictionary search program storage unit 56. Here, a process executed by CPU 10 for generating the table will be described with reference to FIG. 16 showing a flowchart for the process (process of generating an image—keyword setting table).

Referring to FIG. 16, in the process of generating an image—keyword setting table, CPU 10 first sets variable j to zero in step S10 and proceeds to step S20. Variable j refers to a variable corresponding to a unique number of image data in the image—keyword setting table as described above. Namely, which image data in the image—keyword setting table is to be handled in the subsequent procedure is specified by a value of variable j. In the present embodiment, all image IDs stored in the image ID—address table (see FIG. 3) are stored in the image—keyword setting table, and a value of variable j is assigned to each image ID in advance.

In step S20, CPU 10 sets respective values of variable 1 and variable i to zero, and proceeds to step S30. Variable n refers to a value specifying the order of keywords stored in association with each image as described above with reference to FIG. 5. Variable 1 and variable i refer to variables used in the subsequent procedure.

In step S30, it is determined whether the value of variable j is smaller than the number of elements of an array P. The number of elements of array P refers to the number of actual data of objects stored in dictionary DB storage unit 55. When CPU 10 determines that the value of variable j is smaller than the number of elements of array P, CPU 10 proceeds to step S40. Otherwise, CPU 10 ends the process.

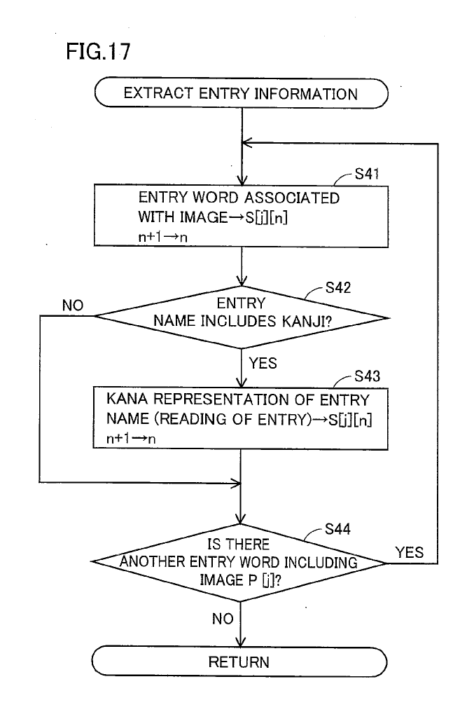

In step S40, CPU 10 performs an entry information extraction process for associating the currently handled image data with data of an entry word associated in the dictionary data with this image data, as a keyword of the image data. Details of this process will be described with reference to FIG. 17 showing a flowchart for a subroutine of the process.

Referring to FIG. 17, in the entry information extraction process, CPU 10 first extracts and stores in step S41 the entry word that is associated with the currently handled image data and stored in the dictionary data, as a keyword at the position specified by S [j] [n] in the image—keyword table, and proceeds to step S42. S [j] [n] refers to the storage location of the n-th keyword concerning the j-th image ID in the image—keyword table. In step S41, CPU 10 stores the entry word as described above and thereafter updates variable n by incrementing the variable by one.

In step S42, CPU 10 determines whether the entry word extracted and stored in the immediately preceding step S41 includes kanji If so, CPU 10 proceeds to step S43. Otherwise, CPU 10 proceeds to step S44.

In step S43, CPU 10 stores a kana representation of the entry word extracted and stored in step S41 (kana representation refers to kana into which the kanji is converted, specifically to “reading of entry” in the dictionary data), at the location specified by S [j] [n] in the image—keyword table, updates variable n by incrementing the variable by one, and proceeds to step S44.

The aforementioned “kana representation” is a representation by phonogram(s) only. In the present embodiment, as described above, “reading of entry” associated with an entry word is a representation of the entry word by phonogram(s) only. Therefore, what is stored in the image—keyword table in step S43 is a representation by phonogram(s) only. In the case where any language to which the present invention is applied uses phonograms only, the information stored here may be pronunciation symbol(s).

In step S44, CPU 10 determines whether there is another entry word associated with image P [j] (currently handled image) and stored in the dictionary data. If so, CPU 10 returns to step S41. Otherwise, CPU 10 returns to the process in FIG. 16.

The entry information extraction process as described above with reference to FIG. 17 thus allows all entry words associated in the dictionary data with each image to be stored in the image—keyword table, respectively as keywords for the image. In the case where an entry word to be stored includes kanji, a kana representation of this kanji is also stored as a keyword in the image—keyword table, separately from the entry word including the kanji.

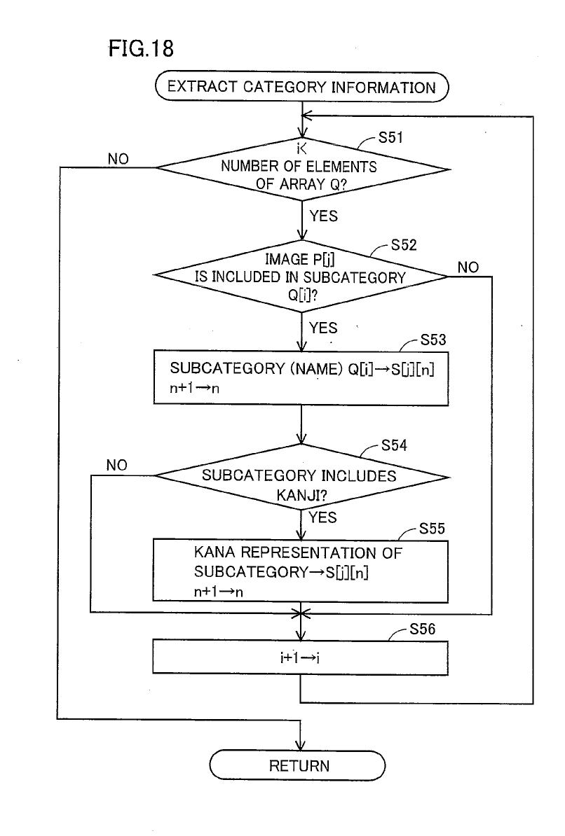

Referring to FIG. 16, after performing the entry information extraction process in step S40, CPU 10 executes a category information extraction process in step S50 for storing, as a keyword in the image—keyword table, the data associated with each image and stored in a cell for “sub category” in the dictionary data. Details of this process will be described with reference to FIG. 18 showing a flowchart for a subroutine of the process.

Referring to FIG. 18, in the category information extraction process, CPU 10 determines in step S51 whether the value of variable i is smaller than the number of elements of an array Q. If so, CPU 10 proceeds to step S52. Otherwise, CPU 10 returns. Here, the number of elements of array Q refers to the total number of different items of information to be stored in the cells for “sub category” in the dictionary data. In the present embodiment, as shown in FIG. 2, the cells for “sub category” show at least two different items of information, namely at least “cultural heritage” and “cultural remains”. Therefore, in the present embodiment, the number of elements of array Q is at least two.

In step S52, CPU 10 determines whether image P [j] (currently handled image) is associated in the dictionary data with the Q [i]-th information item among information items that can be stored as items belonging to the sub category. If so, CPU 10 proceeds to step S53. Otherwise, CPU 10 proceeds to step S56.

In step S53, the name of the Q [i]-th item of the sub category is stored as a keyword at the location S [j] [n] in the image—keyword table, variable n is updated by incrementing the variable by one, and the process proceeds to step S54.

In step S54, CPU 10 determines whether the term stored as a keyword in the immediately preceding step S53 includes kanji. If so, CPU 10 proceeds to step S55. Otherwise, CPU 10 proceeds to step S56.

In step S55, CPU 10 stores, as a keyword at the location specified by S [j] [n] in the image—keyword table, a kana representation of the name of the sub category stored as a keyword in step S53, and proceeds to step S56.

In step S56, CPU 10 updates variable i by incrementing the variable by one and returns to step S51.

In the category information extraction process, when the value of variable i is equal to or larger than the number of elements of array Q as described above, CPU 10 returns to the process in FIG. 16.

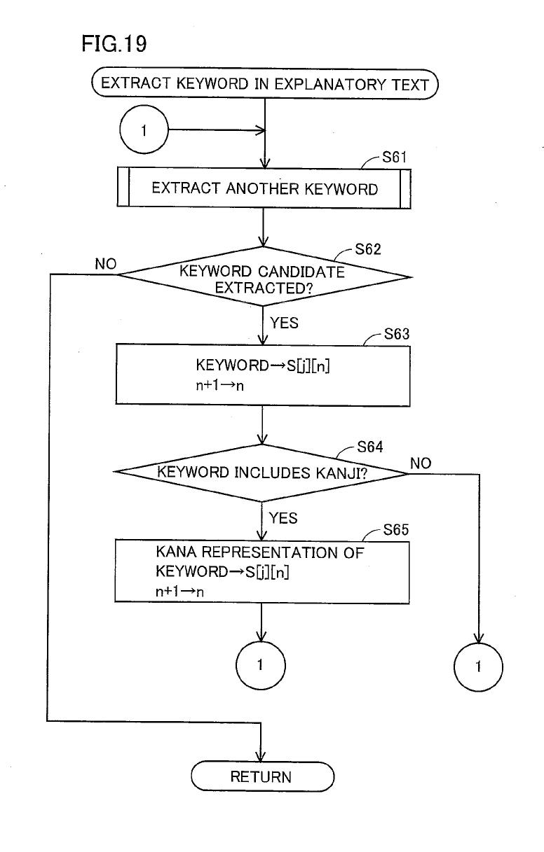

Referring to FIG. 16, after performing the category information extraction process in step S50, CPU 10 performs in step S60 a process of extracting a keyword from an explanatory text, for extracting information from the information associated with each image and stored as an explanatory text in the dictionary data, and storing the extracted information as a keyword in the image—keyword table, and then proceeds to step S70. Details of this process will be described with reference to FIG. 19 showing a flowchart for a subroutine of the process.

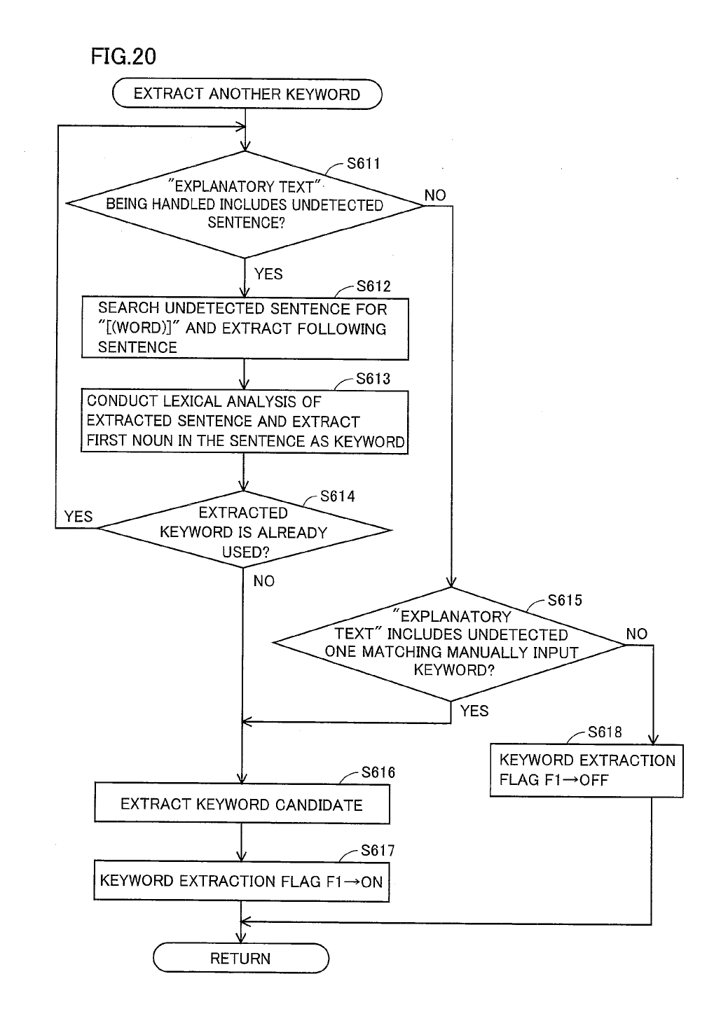

Referring to FIG. 19, in the process of extracting a keyword from an explanatory text, CPU 10 performs in step S61 a process of extracting another keyword, and proceeds to step S62. Here, details of this process will be described with reference to FIG. 20 showing a subroutine of the process.

Referring to FIG. 20, in this process of extracting another keyword, CPU 10 determines in step S611 whether there is a sentence that is not searched for in “explanatory text” associated with the currently handled image in the dictionary data. If so, CPU 10 proceeds to step S612. Otherwise, CPU 10 proceeds to step S615. Here, “explanatory text” to be handled refers to the explanatory text for the entry word associated with the currently handled image in the dictionary data. The fact that a sentence is not searched for means that the sentence is not handled in steps S612 to S614 as described below.

In step S612, CPU 10 searches “explanatory text” to be handled, from the beginning of an un-searched portion of the explanatory text, for a character string placed between brackets ([ ]). When CPU 10 determines that there is such a character string, CPU 10 extracts the sentence following the character string, and proceeds to step S613. Here, CPU 10 extracts the sentence from the beginning to the portion immediately preceding the next character string placed in brackets.

In step S613, lexical analysis of the sentence extracted in the immediately preceding step S612 is conducted, and a noun that first appears in the sentence is extracted as a keyword, and the process proceeds to step S614.

In step S614, CPU 10 determines whether the keyword extracted in the immediately preceding step S613 has already been associated with the currently handled image and stored in the image—keyword table. If so, CPU 10 returns to step S611. Otherwise, CPU 10 proceeds to step S616.

In step S615, CPU 10 determines whether there is a character string that is included in “explanatory text” associated with the currently handled image, is identical to any of the manually input keywords (see FIG. 3), and is not stored as a keyword for the currently handled image in the image—keyword table. If so, CPU 10 proceeds to step S616. Otherwise, CPU 10 proceeds to step S618.

In step S616, CPU 10 temporarily stores the keyword extracted in step S613 or the character string extracted in step S615, as a candidate for a keyword, in candidate keyword storage area 43 of RAM 40, and proceeds to step S617.

In step S617, CPU 10 makes a keyword extraction flag F1 ON and returns to the process in FIG. 19.

In step S618, CPU 10 makes aforementioned keyword extraction flag F1 OFF and returns to the process in FIG. 19.

Referring to FIG. 19, after performing the process of extracting another keyword in step S61, CPU 10 determines in step S62 whether a keyword candidate has been extracted in the process of extracting another keyword in step S61. If so, CPU 10 proceeds to step S63. Otherwise, CPU 10 directly returns to FIG. 16. Here, in the case where aforementioned keyword extraction flag F1 is ON, it is determined that a keyword candidate has been extracted. In the case where this flag is OFF, it is determined that a keyword candidate has not been extracted.

In step S63, CPU 10 allows the keyword candidate temporarily stored in candidate keyword storage area 43 of RAM 40 in step S61 of the process of extracting another keyword, to be stored at the location specified by S [j] [n] in the image—keyword table, updates variable n by incrementing the variable by one, and proceeds to step S64. In step S63, CPU 10 stores the keyword in the image—keyword table, and thereafter clears the contents stored in candidate keyword storage area 43.

In step S64, CPU 10 determines whether the character string stored as a keyword in the immediately preceding step S63 includes kanji. If so, CPU 10 performs the process of step S65 and thereafter returns to the process in FIG. 16. In the case where the character string does not include kanji, CPU 10 directly returns to the process in FIG. 16.

In step S65, CPU 10 allows a kana representation of the character string stored as a keyword in step S63 to be stored at the location specified by S [j] [n] in the image—keyword table, and updates variable n by incrementing the variable by one.

Referring to FIG. 16, after performing the process of extracting a keyword from an explanatory text in step S60, CPU 10 updates variable j by incrementing the variable by one in step S70, and returns to step S20. Accordingly, the image to be handled is changed.

In step S20, CPU 10 sets respective values of variable n, variable 1 and variable i to zero, and proceeds to step S30 and, when the value of variable j is equal to or larger than the number of elements of array P in step S30, CPU 10 ends the process.

In the embodiment heretofore described, for each image associated with an entry word in the dictionary data, keywords associated with the image can be stored in the image—keyword table. When keywords relevant to each image are extracted, an entry word (and a kana representation thereof), a sub category (and a kana representation thereof), a noun first appearing in a sentence subsequent to brackets in an explanatory text of the dictionary data, namely text data satisfying a certain condition in terms of symbols of the brackets, which are associated with the image in the dictionary data, are extracted as the keywords, and stored in the image—keyword table as keywords.

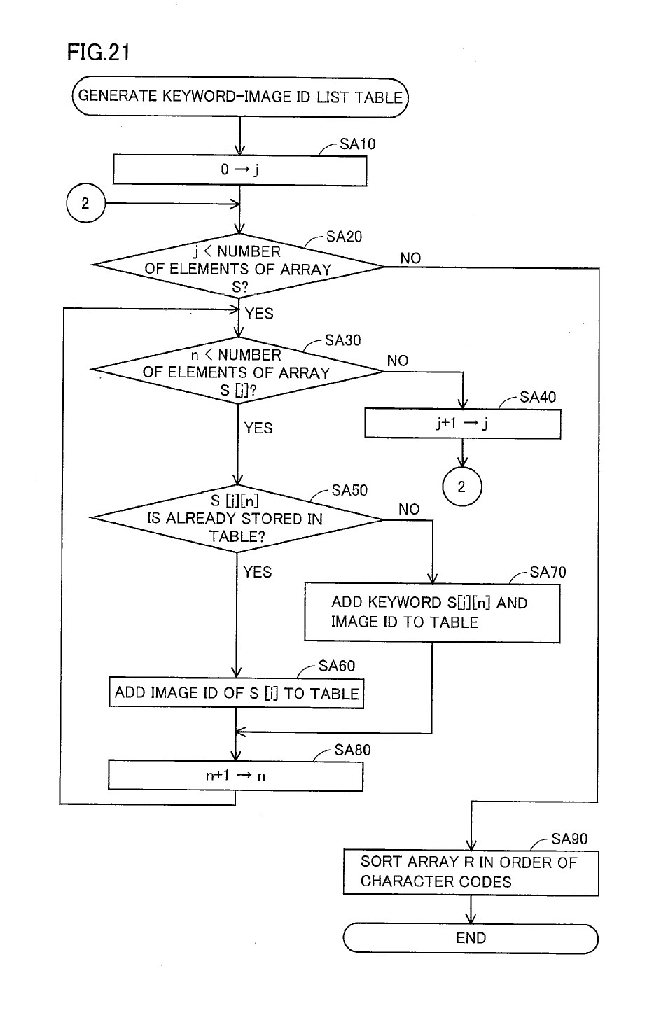

In the present embodiment, a new table (keyword—image ID list table) is generated. This table stores, for each character string stored as a keyword in the image—keyword table, respective image IDs of all images associated with the character string and stored in the image—keyword table. Details of a process for generating such a new table will be described with reference to FIG. 21 showing a flowchart for the process.

Referring to FIG. 21, in the process of generating a keyword—image ID list table, CPU 10 first sets the value of variable j to zero in step SA10, and proceeds to step SA20. Here, variable j is a variable having the same meaning as the meaning defined in relation to the above-described image—keyword table.

In step SA20, CPU 10 determines whether a value of variable j is smaller than the number of elements of an array S. If so, CPU 10 proceeds to step SA30.

In step SA30, CPU 10 determines whether a value of variable n is smaller than the number of elements of an array S [j]. If so, CPU 10 proceeds to step SA50. Otherwise, CPU 10 proceeds to step SA40.

Here, the number of elements of array S [j] refers to a value corresponding to the total number of images for which keywords are stored in the image—keyword table, and specifically refers to the sum of the total number and 1, since variable j in the image—keyword table is defined as starting from “0”.

S [j] [n] is also a variable having the same meaning as S [j] [n] used in the process of generating the image—keyword table as described above.

In step SA50, CPU 10 determines whether a keyword stored at the location S [j] [n] in the image—keyword table has already been stored in the keyword—image ID list table in association with the currently handled image. If so, CPU 10 proceeds to step SA60. Otherwise, CPU 10 proceeds to step SA70.

In step SA70, the keyword at the location S [j] [n] in the image—keyword table is newly added to a cell for the keyword in the keyword—image ID list table. Further, in association with the newly added keyword, the image ID with which the keyword is associated in the image—keyword table is stored. The process then proceeds to step SA80.

In step SA60, CPU 10 adds to the keyword—image ID list table, the image ID associated in the image—keyword table with the same keyword as the keyword of S [j] [n] in the image—keyword table, and proceeds to step SA80.

In step SA80, CPU 10 updates variable n by incrementing the variable by one, and returns to step SA30.

In step SA40, CPU 10 updates variable j by incrementing the variable by one, and returns to step SA20.

When CPU 10 determines in step SA20 that variable j is equal to or larger than the number of elements of array S, CPU 10 sorts the data such that keywords are arranged in the order of character codes in the keyword—image ID list table in step SA90, and then ends the process.

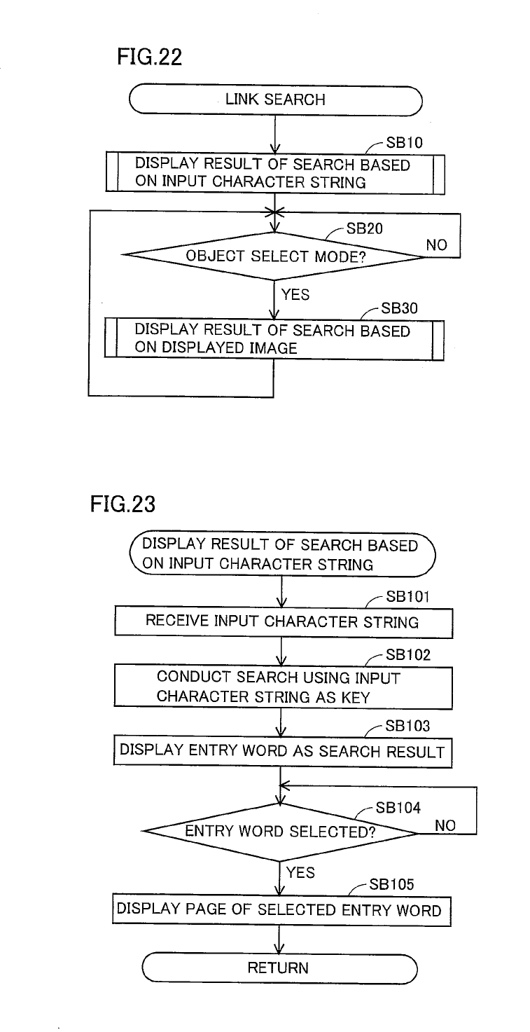

Electronic dictionary 1 displays, based on the dictionary data, information about an entry word searched for based on a character string entered via input unit 20. In the case where the displayed information includes an image and a certain manipulation is performed on input unit 20, the dictionary data is searched based on keywords associated with the displayed image, and the result of the search is displayed. A process for implementing such a series of operations (link search process) will be described with reference to FIG. 22 showing a flowchart for the process.

In the link search process, CPU 10 first executes in step SB10 a process of displaying the result of search based on an input character string, and proceeds to step SB2O. The process in step SB10 will be descried with reference to FIG. 23 showing a flowchart for a subroutine of the process. Referring to FIG. 23, in the process of displaying the result of search based on an input character string, CPU 10 receives in step SB101 a character string entered by a user via input unit 20, and proceeds to step SB102.

In step SB102, CPU 10 searches the dictionary data for an entry word, using the input character string as a keyword, and proceeds to step SB103. Details of the search for an entry word in the dictionary data using an input character string may be derived from well-known techniques, and the description thereof will not be repeated here.

In step SB103, CPU 10 causes display unit 30 to display a list of entry words found by the search in step SB102, and proceeds to step SB104.

In step SB 104, CPU 10 determines whether information for selecting an entry word from the entry words displayed in step SB103 is entered via input unit 20. If so, CPU 10 proceeds to step SB105.

In step SB105, CPU 10 causes display unit 30 to display a page of the selected entry word, and returns to the process in FIG. 22. An example of the manner of displaying the page of the entry word as displayed in step SB105 may be the one for screen 90 as shown in FIG. 9.

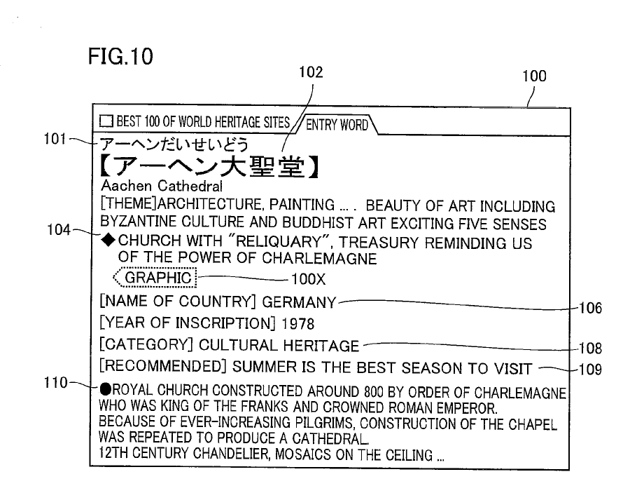

Examples of the manner of displaying a page of a selected entry word may include the one for a screen 100 shown in FIG. 10, in addition to the one for screen 90 shown in FIG. 9.

Referring to FIG. 10, screen 100 shows an information item 101 corresponding to the data stored in a cell for the reading of entry in the dictionary data, an information item 102 displayed that corresponds to the data stored in a cell for the entry word in the dictionary data, an information item 106 displayed based on the data stored in a cell for the country name in the dictionary data, an information item 108 displayed based on the data stored in a cell for the sub category in the dictionary data, and information items 104, 110 displayed based on the data stored in a cell for the explanatory text in the dictionary data. Displayed screen 100 does not include an image corresponding to the data stored in a cell for the image ID, such as image 90A of screen 90. Instead of the image, an icon 100X is displayed. In the case where screen 100 is displayed instead of screen 90, CPU 10 causes display unit 30 to display an image corresponding to the data stored in a cell for the image ID, on condition that icon 100X is manipulated. In the case where screen 100 shows a page of an entry word with which no image ID is associated in the dictionary data, CPU 10 does not cause icon 100X to be displayed in screen 100.

Referring back to FIG. 22, after performing the process of displaying the result of search based on an input character string in step SB10, CPU 10 determines in step SB20 whether an instruction to use electronic dictionary 1 in an object select mode is entered via input unit 20. If so, CPU 10 proceeds to step SB30. Here, the object select mode can be used to select an object (image 90A) of screen 90 as shown in FIG. 9 or select an icon corresponding to an object (such as an icon for reproducing audio data).

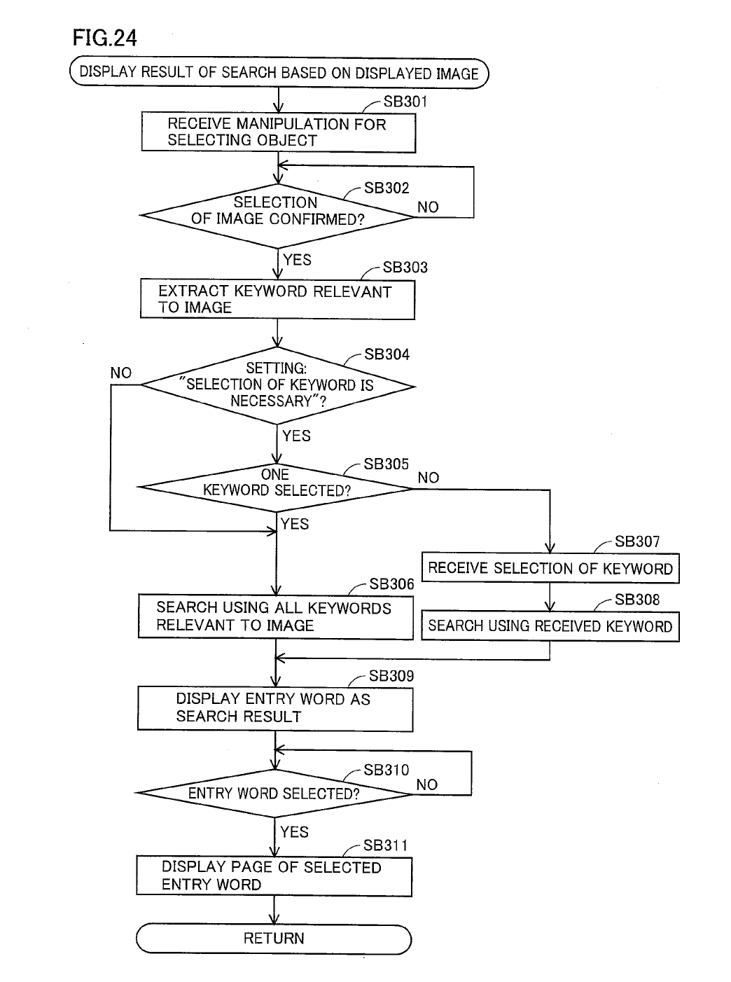

In step SB30, CPU 10 performs a process of displaying the result of search based on a displayed image, and thereafter returns to step SB20. Here, the instruction to use the electronic dictionary in the object select mode is entered by manipulation of S key 24, for example. The process of step SB30 will be described with reference to FIG. 24 showing a flowchart for a subroutine of the process.

Referring to FIG. 24, in the process of displaying the result of search based on a displayed image, CPU 10 first receives in step SB301 manipulation of a user for selecting an object from objects (or text data) displayed by display unit 30, and proceeds to step SB302.

In step SB302, CPU 10 determines whether the manipulation received in step SB301 is done for selecting an image and whether another manipulation for confirming the former manipulation is received. If so, CPU 10 proceeds to step SB303.

In step SB303, CPU 10 extracts a keyword/keywords stored in the image—keyword table in association with the image selected in step SB302, and proceeds to step SB304.

In step SB304, the setting stored in keyword selection/non-selection setting storage area 44 is checked to determine whether the setting is that selection of a keyword is necessary. If so, the process proceeds to step SB305. Otherwise, namely when it is determined that the stored setting is that selection of a keyword is unnecessary, the process proceeds to step SB306. Here, the setting stored in keyword selection/non-selection setting storage area 44 refers to information about whether selection of a keyword is necessary or unnecessary, which is set by a user by entering the information via input unit 20 (or by default).

In step SB305, CPU 10 determines whether one keyword is extracted in step SB303. If so, CPU 10 proceeds to step SB306. Otherwise, namely when CPU 10 determines that more than one keyword is extracted in step SB303, CPU 10 proceeds to step SB307.

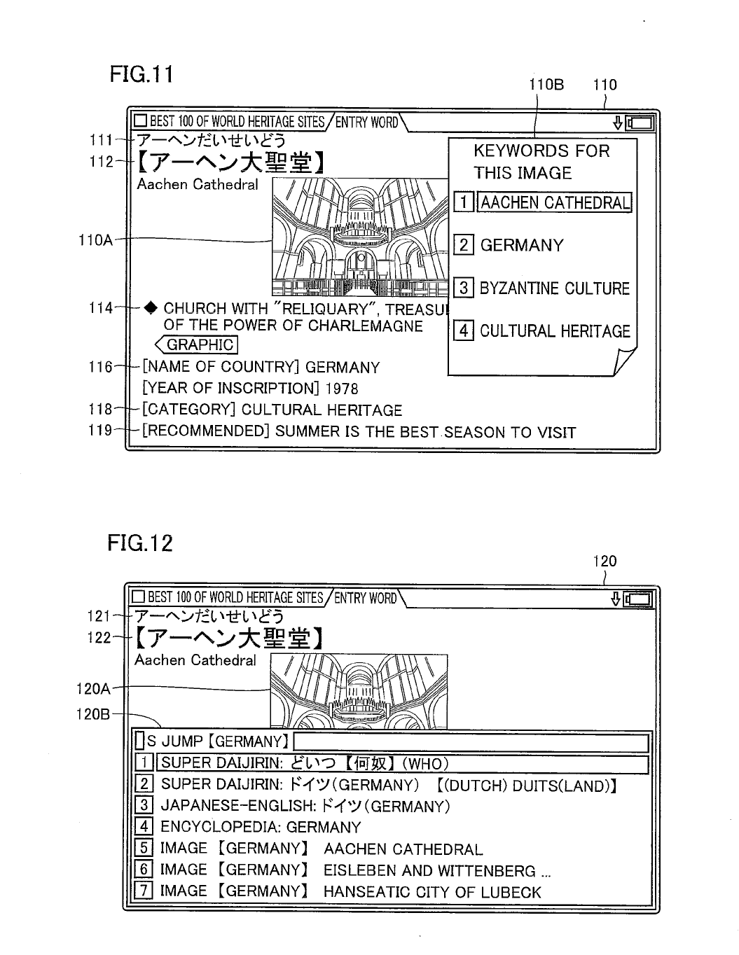

In step SB307, CPU 10 receives input of information for selecting a keyword from a plurality of keywords extracted in step SB303, and proceeds to step SB308. When the input of information for selecting a keyword is received in step SB307, a screen like the one as shown in FIG. 11 is displayed.

Referring to FIG. 11 a screen 110B is displayed on a screen 110 in such a manner that screen 110B overlaps the page for the entry word shown in FIG. 9. Information items 111, 112, 114, 116, 118, 119, and an image 110A on screen 110 correspond respectively to information items 91, 92, 94, 96, 98, 99, and image 90A on screen 90. Screen 110B shows a list of keywords associated with the image ID of image 110A in the image—keyword table. A user appropriately manipulates input unit 20 to select a keyword from the listed keywords. In step SB307, CPU 10 receives the information about this manipulation by the user. Referring again to FIG. 24, in step SB308, an entry word in the dictionary data is searched for based on the keyword selected according to the information received in step SB307, and the process proceeds to step SB309.

In step SB306, based on all keywords extracted in step SB303, an entry word in the dictionary data is searched for, and the process proceeds to step SB309. The search in step SB306 may be OR search or AND search based on all keywords.

In step SB309, a list of entry words found by the search is displayed by display unit 30, and the process proceeds to step SB310. Here, a screen like the one as shown in FIG. 12 is displayed by display unit 30.

Referring to FIG. 12, a screen 120 displays information items 121, 122 and an image 120A corresponding respectively to information items 91, 92 and image 90A in FIG. 9, as well as a screen 120B displaying a list of entry words found by the search in step SB306 or step SB308.

In step SB310, CPU 10 determines whether information for selecting an entry word from those found by the search and displayed in step SB309 is entered. If so, CPU 10 proceeds to step SB311.

In step SB311, CPU 10 causes a page of the selected entry word to be displayed in a manner like screen 90 shown in FIG. 9 for example, and returns to the process in FIG. 22.

In the present embodiment as described above, an image displayed by display unit 30 as information relevant to an entry word in the dictionary data is selected, and accordingly the search can be conducted for an entry word based on a keyword/keywords associated with the image. As described above with reference to FIG. 11, in the case where more than one keyword is associated with the image, the more than one keyword associated with the image may be displayed by display unit 30, so that a user can enter information for selecting a keyword from these keywords.

The present embodiment has been described in connection with the case where image data is used as an example of object data. In the case where audio data associated with an entry word in the dictionary data is used as object data, a displayed list of keywords associated with the object data like the one shown by screen 110B in FIG. 11 may be provided in the following way. Specifically, on condition that a special manipulation is performed on input unit 20 while the audio data is being reproduced, a screen of a list of keywords associated with the audio data may be displayed.

Further, the present embodiment has been described in connection with the case where the dictionary data is stored in the body of electronic dictionary 1. The dictionary data, however, may not necessarily be stored in the body of electronic dictionary 1. Namely, electronic dictionary 1 does not need to include dictionary DB 55. Electronic dictionary 1 may be configured to use dictionary data stored in a device connected to the electronic dictionary via a network for example so as to produce for example an image—keyword table.

Electronic dictionary 1 may employ, as a manner of displaying a page of an entry word, the manner of display as shown in FIG. 10 where an image associated with the entry word is not directly displayed but an icon representing the image is displayed. A modification of the link search process where a page of an entry word is displayed in the manner as shown in FIG. 10 will be described below.

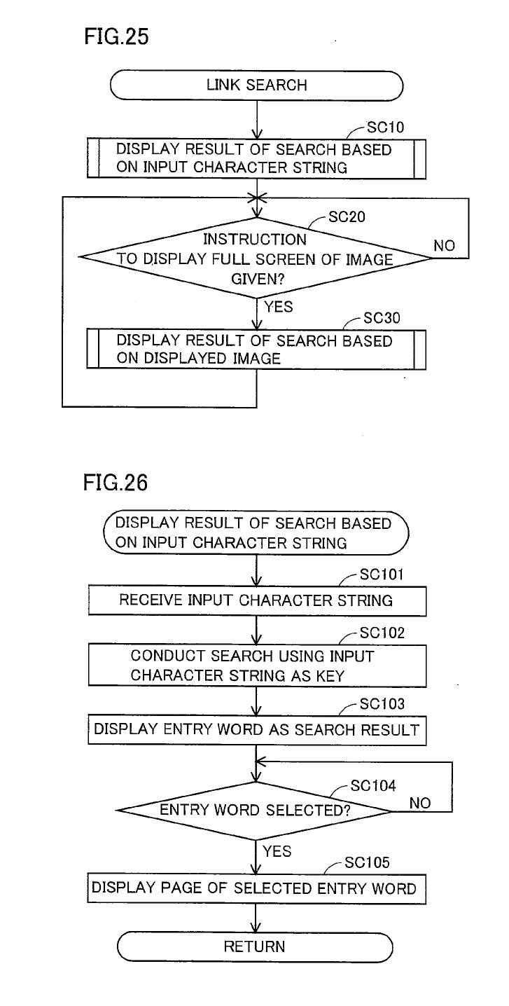

FIG. 25 is a flowchart for a modification of the link search process. Referring to FIG. 25, in the modification of the link search process, CPU 10 first executes in step SC10 a process of displaying the result of search based on an input character string, and proceeds to step SC20. The process in step SC10 will be described with reference to FIG. 26 showing a flowchart for a subroutine of the process. Referring to FIG. 26, the process of displaying the result of search based on an input character string is performed in this modification similarly to the process described above with reference to FIG. 23. Specifically, CPU 10 receives a character string entered by a user via input unit 20 in step SC101, searches for an entry word in the dictionary data using the input character string as a keyword in step SC102, causes in step SC103 display unit 30 to display the entry word found by the search in step SC102, and proceeds to step SC104. In step SC104, CPU 10 determines whether information for selecting an entry word from entry words displayed in step SC103 is entered via input unit 20. If so, CPU 10 proceeds to step SC105. In step SC105, CPU 10 causes display unit 30 to display a page of the selected entry word, and returns to the process in FIG. 25.

Referring again to FIG. 25, after performing the process of displaying the result of search based on an input character string in step SC10, CPU 10 determines in step SC20 whether an instruction is given to cause display unit 30 to display a full screen of an image that is associated in the dictionary data with the displayed entry word. This instruction is effected by, for example, manipulation of input unit 20 for selecting icon 100X and confirming the selection of the icon. When it is determined that the instruction is given, the process proceeds to step SC30.

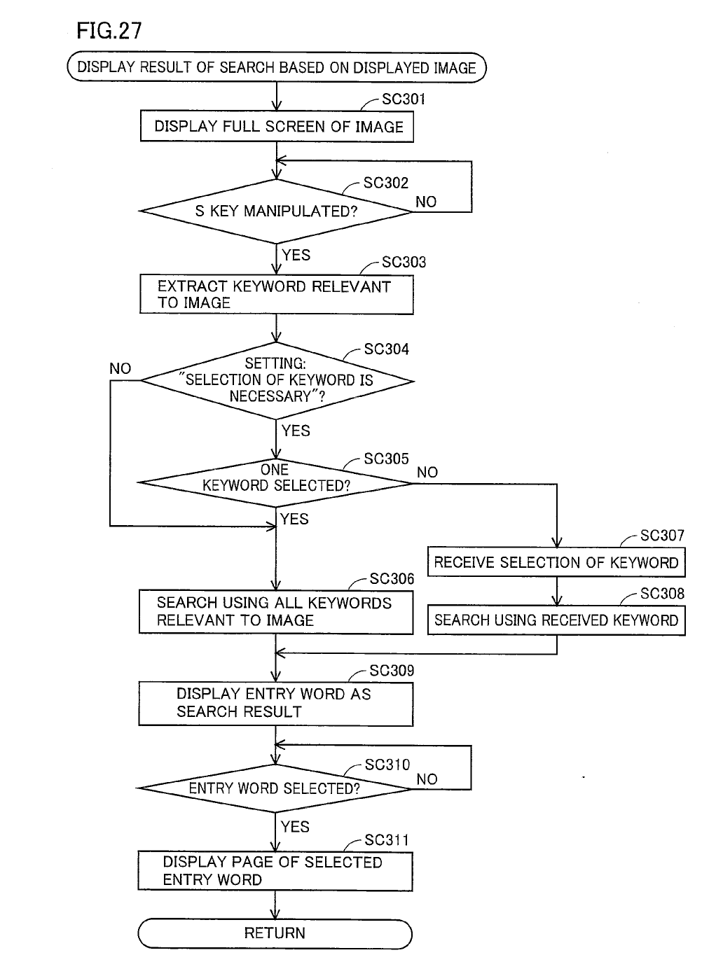

In step SC30, CPU 10 performs a process of displaying the result of search based on the displayed image, and returns to step SC20. The process in step SC30 will be described with reference to FIG. 27 showing a flowchart for the subroutine of this process.

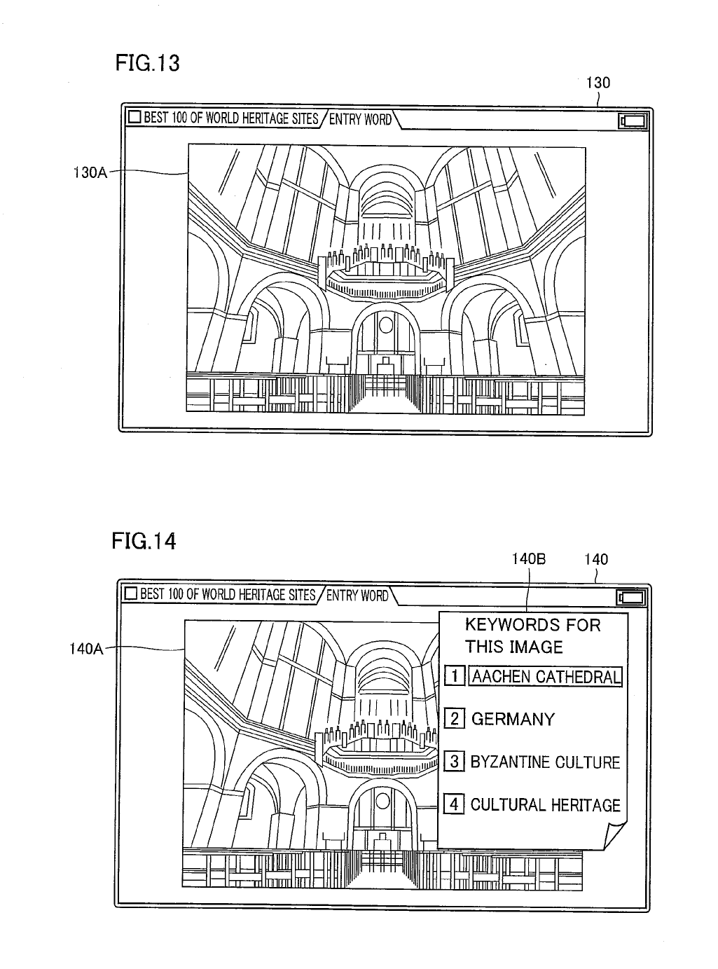

Referring to FIG. 27, in the process of displaying the result of search based on a displayed image, CPU 10 first causes in step SC301 display unit 30 to display a full screen of an image like the one for example shown in FIG. 13, and proceeds to step SC302. A screen 130 shown in FIG. 13 displays an image 130A associated with the entry word in the screen (screen 100) which has been displayed until image 130A is displayed, and image 130A is displayed to extend over an almost entire area of screen 130.

Referring again to FIG. 27, in step SC302, CPU 10 determines whether S key 24 is manipulated. If so, CPU 10 proceeds to step SC303.

In step SC303, CPU 10 extracts a keyword/keywords stored in the image—keyword table in association with the image selected in step SC302, and proceeds to step SC304.

In step SC304, the setting stored in keyword selection/non-selection setting storage area 44 is checked to determine whether the setting is that selection of a keyword is necessary. If so, the process proceeds to step SC305. Otherwise, namely when it is determined that the stored setting is that selection of a keyword is unnecessary, the process proceeds to step SC306. Here, the setting stored in keyword selection/non-selection setting storage area 44 refers to information about whether selection of a keyword is necessary or unnecessary, which is set by a user by entering the information via input unit 20 (or by default).

In step SC305, CPU 10 determines whether one keyword is extracted in step SC303. If so, CPU 10 proceeds to step SC306. Otherwise, namely when CPU 10 determines that more than one keyword is extracted in step SC303, CPU 10 proceeds to step SC307.

In step SC307, CPU 10 receives input of information for selecting a keyword from a plurality of keywords extracted in step SC303, and proceeds to step SC308. When the input of information for selecting a keyword is received in step SC307, a screen like the one as shown in FIG. 14 is displayed.

Referring to FIG. 14 a screen 140B is displayed on a screen 140 in such a manner that screen 140B overlaps screen 130 shown in FIG. 13. An image 140A of screen 140 corresponds to image 130A of screen 130. Screen 140B shows a list of keywords associated with the image ID of image 140A in the image—keyword table. A user appropriately manipulates input unit 20 to select a keyword from the listed keywords. In step SC307, CPU 10 receives the information about this manipulation by the user.

Referring again to FIG. 27, in step SC308, an entry word in the dictionary data is searched for based on the keyword selected according to the information received in step SC307, and the process proceeds to step SC309.

In step SC306, based on all keywords extracted in step SC303, an entry word in the dictionary data is searched for, and the process proceeds to step SC309. The search in step SC306 may be OR search or AND search based on all keywords.

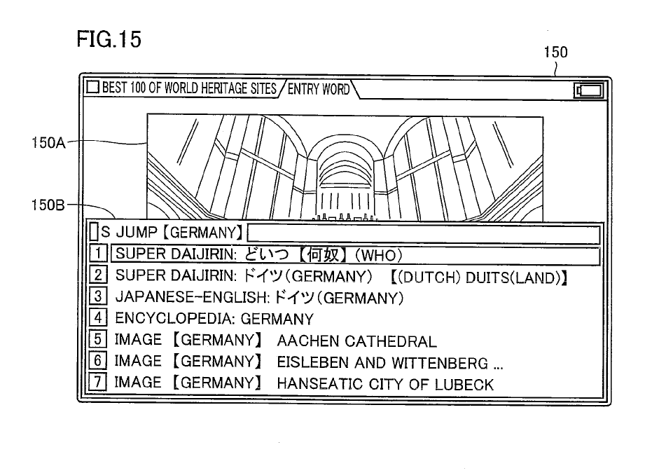

In step SC309, a list of entry words found by the search is displayed by display unit 30, and the process proceeds to step SC310. Here, a screen like the one as shown in FIG. 15 is displayed by display unit 30. Referring to FIG. 15, a screen 150 displays an image 150A corresponding to image 130A in FIG. 13, as well as a screen 150B showing a list of entry words found by the search in step SC306 or step SC308.

In step SC310, CPU 10 determines whether information for selecting an entry word from those found by the search and displayed in step SC109 is entered. If so, CPU 10 proceeds to step SC311.

In step SC311, CPU 10 causes a page of the selected entry word to be displayed in a manner like screen 100 shown in FIG. 10 for example, and returns to the process in FIG. 25.

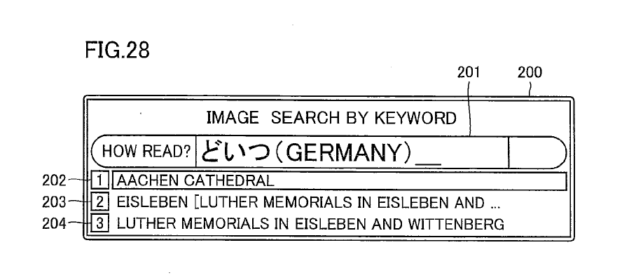

In the present embodiment as described above, screen 90 shown in FIG. 9 and screen 100 shown in FIG. 10 are provided as examples of how electronic dictionary 1 displays a page of each entry word in the dictionary data. In any of the case where the page is displayed as shown in FIG. 9 and the case where the page is displayed as shown in FIG. 10, the process of displaying the result of search based on an input character string (see FIG. 23 or 26) first displays by display unit 30 a list of entry words found by the search based on the input character string, and thereafter displays a page of an entry word. An example of such a screen showing a list may be the screen as shown in FIG. 28 for example. Referring to FIG. 28, a screen 200 displays a display section 201 where a character string entered by a user is displayed, and displays a list of entry words, as items 202 to 204, found by the search.

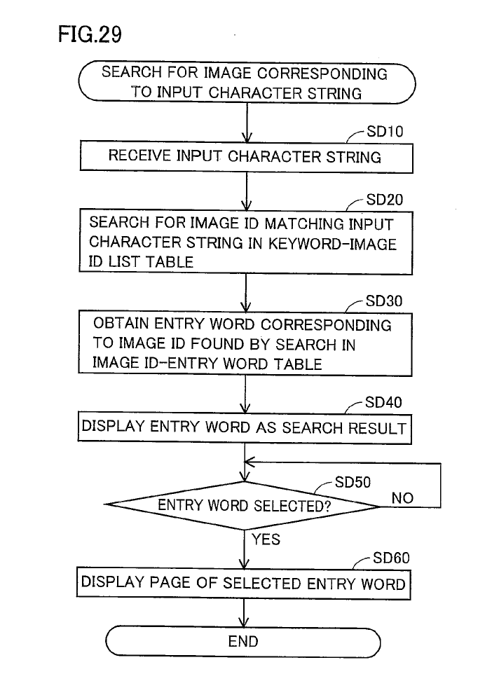

Electronic dictionary 1 receiving a character string entered by a user can search for not only an entry word in the dictionary data but also a keyword associated with object data (image data in the present embodiment). The result of such a search is provided to the user in the form of information as follows. First, the search for a keyword as described above is conducted. Then, the image ID associated in the keyword—image ID list table with the keyword found by the search is extracted. Further, an entry word associated in the dictionary data with the extracted image ID is extracted, and thereafter the extracted entry word is provided. CPU 10 executes a process for conducting the search in the above-described manner (search for image corresponding to input character string). A flowchart for this process is shown in FIG. 29.

Referring to FIG. 29, in the process of searching for an image corresponding to an input character string, CPU 10 receives a character string entered by a user via input unit 20 in step SD10, and proceeds to step SD20.

In step SD20, CPU 10 searches the keyword—image ID list table for a keyword matching the input character string, and proceeds to step SD30. Details of the search for a keyword in the table using an input character string as a keyword may be derived from well-known techniques, and the description thereof will not be repeated here.

In step SD30, CPU 10 extracts an image ID stored in the keyword—image ID list table (or image—keyword table) in association with the keyword found by the search in step SD20, and obtains (picks up) an entry word associated with the image ID in the image ID—entry word table, and proceeds to step SD40.

In step SD40, CPU 10 causes display unit 30 to display the entry word obtained in step SD30, in the manner as shown in FIG. 28 for example, and proceeds to step SD50.

In step SD50, CPU 10 determines whether information is entered via input unit 20 for selecting an entry word from entry words displayed in step SD40. If so, CPU 10 proceeds to step SD60.

In step SD60, CPU 10 causes display unit 30 to display a page of the selected entry word, and ends the process.

In the process of searching for an image relevant to an input character string as described above, reference is made to the keyword—image ID table and image ID—entry word table stored in ROM 50. The configuration of electronic dictionary 1 is not limited to this. The process can be executed as long as at least the image—keyword table or keyword—image ID list table is stored in ROM 50.

In the present embodiment, the image ID—entry word table is produced from the dictionary data, and the image—keyword table is produced based on the image ID—entry word table. These tables, however, may not necessarily be produced by electronic dictionary 1. Namely, these tables generated in advance may be stored in ROM 50. Further, these tables may not necessarily be stored in ROM 50, and may be stored in a memory of a device that can be connected to electronic dictionary 1 via a network or the like. The dictionary search program stored in dictionary search program storage unit 56 or the image display program stored in image display program storage unit 57 may be configured such that CPU 10 accessing the memory as required carries out each process as described above in connection with the present embodiment.

It should be construed that embodiments disclosed herein are by way of illustration in all respects, not by way of limitation. It is intended that the scope of the present invention is defined by claims, not by the above description of the embodiments, and includes all modifications and variations equivalent in meaning and scope to the claims. It is intended that above-described embodiments are implemented in the form of a combination wherever possible.

### INDUSTRIAL APPLICABILITY

The present invention can improve the usefulness of electronic devices, and is applicable to an electronic device, a method of controlling the electronic device and a program product.

1. An electronic device comprising:
an input unit;
a search unit for searching for an entry word in dictionary data including entry words and text data and object data associated with said entry words, based on information entered via said input unit; and
a relevant information storage unit for storing information associating said object data with a keyword,
said search unit conducting a search to find said keyword included in said relevant information storage unit and corresponding to said information entered via said input unit, conducting a search to find said object data associated in said relevant information storage unit with said found keyword and conducting a search to find an entry word associated in said dictionary data with said found object data.

2. The electronic device according to claim 1, further comprising an extraction unit for extracting said keyword from said dictionary data.

3. The electronic device according to claim 2, wherein
said extraction unit extracts said entry word associated in said dictionary data with said object data, and said extraction unit extracts said entry word as said keyword.

4. The electronic device according to claim 2, wherein
said extraction unit extracts data satisfying a certain condition with respect to a specific symbol, from said text data associated in said dictionary data with said object data, and said extraction unit extracts said data as said keyword.

5. The electronic device according to claim 2, further comprising an input data storage unit for storing data entered via said input unit, wherein
said extraction unit extracts, from said text data associated in said dictionary data with said object data, data matching the data stored in said input data storage unit, and said extraction unit extracts said data as said keyword.

6. The electronic device according to claim 2, wherein in a case where said keyword extracted for said object data includes an ideogram, said extraction unit further extracts a character string represented by only a phonogram of the keyword, as said keyword relevant to said object data.

7. The electronic device according to claim 1, wherein
said object data is image data.

8. The electronic device according to claim 1, wherein
said object data is audio data.

9. A method of controlling an electronic device for conducting a search using dictionary data stored in a predetermined storage device and including entry words and text data and object data associated with said entry words, comprising the steps of:
storing information associating said object data with a keyword of said object data;
conducting a search to find said object data stored in association with said keyword corresponding to information entered to said electronic device; and
conducting a search for an entry word associated in said dictionary data with said found object data.

10. A program product having a computer program recorded for causing a computer to execute the method of controlling an electronic device as recited in claim 9.
